(19) United States
(12) Patent Application Publication
(10) Pub. No.: US 2011/0095087 A1
(43) Pub. Date: Apr. 28, 2011

(54) SMART LOGISTIC SYSTEM WITH RFID READER MOUNTED ON A FORKLIFT TINE

(76) Inventors: Israel Master, Petach Tikva (IL); Shlomo Berliner, Kiryat Ono (IL); Nehemia Shefy, Raanana (IL); Ammon Feldman, Tel. Mond (IL); Benny Bialik, Rehovot (IL); Shmuel Zivan, Kiryat Tivon (IL); Mordechay Goldrat, Kfar Saba (IL)

(21) Appl. No.: 13/000,827

(22) PCT Filed: Jul. 13, 2009
(86) PCT No.: PCT/IL09/00699

§ 371 Date: Dec. 22, 2010

Related U.S. Application Data
(60) Provisional application No. 61/080,741, filed on Jul. 15, 2008.

(51) Int. Cl. G06Q 90/00; G06K 7/01

(52) U.S. Cl. 235/385; 340/10.1

(57) ABSTRACT

A smart logistic system for interrogating radio frequency identification (RFID) tags, including: a) a portable support and protective structure adapted for mounting on a tine of the forklift, the support and protective structure including a mounting section, includes a top surface and a bottom surface, and a component section each extending along at least a portion of the support and protective structure, the mounting section configured to secure the support and protective structure to the tine and the component section including a compartment; b) a RFID reader securely accommodated inside the compartment; c) a RFID antenna; and d) a power source securely accommodated in the component section. The support and protective structure being portable and the RFID reader being self sufficient, the smart logistic system can be deployed to another tine of a forklift within seconds.

### FIELD OF THE INVENTION

The present invention relates to radio frequency identification (RFID) systems for use in detecting, tracking, monitoring and controlling packages and other articles in specified areas such as, but not limited to, warehouses. More specifically, the present invention relates to detecting, tracking, monitoring and controlling packages and other articles, placed on smart pallets that contain a built-in RFID tag and whereas the RFID tag is read by a reader disposed on a forklift tine.

### BACKGROUND OF THE INVENTION AND PRIOR ART

Most of the manufacturers are using information technology (IT) systems to supervise and manage the production and logistic activities, such as an enterprise resource planning (ERP) with warehouse management systems (WMS) or any other IT infrastructure that allows the manufacturer to manage the daily activities. Time and accuracy are major factors for any manufacturer to improve its revenues, to provide better services and to have better ability to manage performance.

Many manufacturers are using pallets to move, transfer and deliver the production. For most of the ERP system the pallet is the basic unit to be controlled and managed. The ability to manage and control pallets by using less human power, less manual operations, higher accuracy and with no human error becomes a key factor to achieve better performance.

The use of a radio frequency identification (RFID) system to identify and monitor objects is well known in the art. In such a system RFID labels or tags are attached or otherwise coupled to objects to be tracked or otherwise monitored. RFID technology refers to passive miniature antennae-containing tags requiring no internal power, known as “smart tags” that can be embedded in or attached to a product or material to convey information that can be electronically read. Active tags, containing an internal power source, can also be used in some cases for similar purposes.

Reference is made to FIG. 1 (prior art) showing a conventional RFID based IT system 10 for managing production and logistic activities, the system including a reader 30 and a tag 20. The tag generates an electromagnetic response to an electronic signal from reader 30, transmitted by an antenna 32 coupled to reader 30. Antenna 32 transmits an RF signal 35 which activates passive tag 20 thereby tag 20 transmits back to reader 30 a modulated signal 25, which contains the information stored in tag 20. Typically, RFID system 10 further includes middleware subunit 40 and an organizational application 50, such as ERP (Enterprise Resource Planning), SAP (Systems Applications and Products) and WMS (Warehouse Management System) that controls RFID system 10, whereas middleware 40 mediates between reader 30 and application 50.

An RFID system may utilize a gated antenna array that includes a pair of vertically mounted antennas. The vertically mounted antennas each produce and emit the electromagnetic interrogation field at a specific frequency when excited by suitable electronic circuitry. The interrogation fields together form an interrogation zone in which the RFID device can be interrogated and detected. If an RFID transponder is positioned within the interrogation zone for a sufficient time and is able to receive appropriate commands from the reader as well as adequate radio frequency (RF) signal power to operate the device, it will become stimulated and transmit, either by generation of a RF signal or by reflective means, commonly described as modulated backscatter, a uniquely coded signal that is received by the antennas or a separate receiving antenna. The response signal can be read by the reader, typically with a readable range on the order of a few feet, though broader or narrower ranges are possible.

An RFID tag is a transponder that can be either an active transponder or a passive transponder. An active transponder has its own internal battery, whereas a passive transponder does not have its own internal battery and generates its required power through electromagnetic coupling to an interrogation field. Passive transponders are generally less expensive than active transponders. One traditional drawback of RFID systems which include passive transponders has been their relatively limited read range.

The terms “RFID reader”, “RFID scanner”, “reader” and “scanner” are used herein interchangeably.

A common application of RFID systems is in tracking packages and other articles traveling on conveyors, for example in a distribution center, managing warehouses and the like. In order to identify and properly route individual packages traveling through a distribution center, it is necessary to provide and detect an identification code associated with each package. Traditionally, this has been done with printed bar codes, using bar code readers that may be placed over conveyor belts. When using such bar codes systems it is necessary to orient the packages with the bar codes facing upwardly and otherwise to orient and place the packages on the conveyor belt so that the bar codes will be detected and not be damaged by forklifts.

Several problems in implementing RFID technology have been encountered. In a warehouse or distribution center, some tags fail to be read by scanners due to shielding of radio signals resulting from RF blocking materials (like metal or liquids), interference between multiple tags nodes in the distribution of emitted radio signals, distance between tags and scanners, and other factors. For example, in a pallet with multiple stacked cases of products, products in the center may not be read easily, while those on the outer portions of the pallet may be readily detected by scanners.

In the case of detection of RFID tagged packages on a conveyor, improvements in reading distance of passive RFID tags may however create another problem. The conveyor reader may simultaneously detect multiple tagged packages at one time, especially if such packages are located relatively close together on the conveyor. It is not desirable to turn the conveyor reader power down to reduce the reading range, as the position of a package and its contents can greatly attenuate the signal, making the reading unreliable at reduced power. Thus there is a need to discriminate between multiple detected packages according to their location on the conveyor.

One of the ways to try and overcome part of the above setbacks is by incorporating cascading smart tags, wherein groups of products such as cases, pallets, or truckloads are associated with a “macro tag” that provides information about smaller groupings of products or individual products and their associated tags.

To overcome some of the above problems, U.S. Pat. No. 7,088,248 assigned to Forster introduced different RFID detection systems that include jamming signal transmitters to inhibit detection of RFID devices outside of a specified area; Or includes an RFID device reader and jamming signal transmitters operatively coupled to the reader, to aid the reader in avoiding detection of RFID devices outside of a predetermined specified area; Or includes a pair of spaced-apart loops for emitting low-frequency electromagnetic fields, wherein the fields are substantially opposite in phase.

One of the problems detected in prior art RFID systems was the fact that the RFID tags had to be attached to or otherwise placed on the outer surface of the pallet in order to be readable by a scanner. Externally attached RFID tags are exposed to damage by lift truck (for example, a forklift) and are readable in certain angles only.

Reference is made to FIG. 2 (prior art) which illustrate the influence of angle θ between the surface of an RFID tag 20 and the transmission axis of the RF signal transmitted by antenna 32 of an RFID reader 30. An RFID tag 20 has an effective field of view within which envelop the antenna of an RFID tag 20 has a good reception of RF signal 35 sent by an RFID reader 30. If θ>φ/2, the reliability of the reception of the activation signal 35 by tag 20 decreases. When θ=90° (θc in FIG. 2), reception is minimal and the reliability of the reception of the activation signal 35 by tag 20 is typically reduced to 50%. Hence, when a forklift approaches a pallet having an RFID tag 20 attached to a central supporting cube of the pallet, in an orientation of θ=90°, no reading will be rendered. In the perpendicular orientation full reading will be rendered.

To overcome some of the above problems, WO/2008/047353 by Zvika Edelstain et al, the disclosure of which is incorporated by reference for all purposes as if fully set forth herein, provides a smart pallet that overcomes the orientation problem. Reference is made to FIG. 3 (prior art) which illustrates a schematic perspective view of an RFID device 100 containing RFID tag 120 for pallet 190, whereas device 100 typically serves as the middle support cube (110) of pallet 190. Reference is also made to FIG. 4 (prior art), which illustrates a bottom view of pallet 190 with RFID device 100 and to FIG. 5, which illustrates the indifference of the approach direction of forklift 50, having mounted readers 30 for reading RFID tag 120 embedded inside RFID device 100, which is integrated into pallet 190.

Another problem of prior art systems occurs when pallet 190 is stacked with merchandise which contains radio shielding or disturbing materials such as metal.

US patent application 20060255950 ('950) by William Roeder et al., provides a solution that requires a complex reading mechanism including at least one ruggedized antenna mounted on the tine of a lift truck (for example, a forklift). The antenna can be configured to read RFID tags on pallets that are loaded on the lift truck and communicate the tag information to a warehouse management system. Reference is made to FIG. 6 (prior art) which schematically illustrates antenna 80 for mounting on a forklift tine, being connected to an RFID reader disposed on truck 50, typically at a static location of truck 50 such as mast 54 of truck 50. Since antenna 80 is not a standalone device and must be coupled with an RFID reader 60, a complex cable mechanism 82, for example a pulley (84) based mechanism, must be devised in order for antenna 80, or another physical solution, disposed on a forklift tine, to stay connected to RFID reader 60, while the forklift tines operationally change elevation. Such physical solution requires a relatively long coax cable that significantly weakens signal, while communicating with reader 60. Furthermore, it is complicated to move antenna 80 from one forklift to another, because of the cable mechanism 82 (or other physical solution), which is prone to break downs.

Yet another problem was detected in previous systems were the systems use “semi active” RFID UHF tags requiring power source attached to or embedded in plastic pallets. The power source needs to be replaced quite frequently, therefore requires constant maintenance being costly thus not practical.

The present invention introduces an improved system that overcomes most of the known problems and ensures that products are detected even when there is RF shielding or other problems that causes some tags in a group of products not to be read.

The present invention introduces a special passive smart tag requiring no power source, embedded into a pallet for the life of the pallet with no need of any special maintenance. The smart tag is integrated in a special support cube, sealed to protect the tag from any fluid penetration. The smart tag is implanted substantially vertically into the cube, forming an angle of 45° relative to each of the cube vertical sides, such that the smart tag can be read in a high level reliability and long at ranges by a lift truck (for example, a forklift) approaching the pallet from any of the 4 possible directions.

The terms “RFID reader”, “RFID scanner”, “reader” and “scanner” are used herein interchangeably.

### SUMMARY OF THE INVENTION

The principle intention of the present invention includes providing an RFID based smart logistic system, designed to provide manufacturers with an automatic, hands-free, fast and advanced solution in order to track, monitor and control the logistic process.

The smart logistic system further includes an innovative, portable sleeve, which is operationally disposed on a forklift tine, and includes a complete RFID reader. The RFID reader communicates with a control unit system, which is typically disposed in the forklift cabin, preferably using wireless communication means. The control unit system in the forklift cabin typically communicates with the site IT system. Accordingly, it is the intention of the present invention is to provide a novel device in a portable sleeve form, for disposing on a forklift tine.

In variations of the present invention, the RFID reader communicates with the site IT system through an access point.

According to the teachings of the present invention there is provided a smart logistic system for interrogating radio frequency identification (RFID) tags, including:
a) a first portable support and protective structure adapted for mounting on a first tine of the forklift, the first support and protective structure including a mounting section, includes a top surface and a bottom surface, and a component section each extending along at least a portion of the first support and protective structure, the mounting section configured to secure the first support and protective structure to the first tine and the component section including a compartment;
b) a RFID reader securely accommodated inside the compartment;
c) a RFID antenna; and
d) a power source securely accommodated in the component section.

The RFID reader is self sufficient and operatively coupled to the RFID antenna. The RFID antenna is mounted onto the first support and protective structure so as to permit transmitting and receiving of RF signals. Preferably, at least a portion of the first support and protective structure is configured to be used as the RFID antenna.

It should be noted that since the first support and protective structure is portable and since the RFID reader is self sufficient, the smart logistic system can be deployed to another tine of a forklift within seconds.

Preferably, the compartment is disposed inside the mounting section, and essentially flush with the inner surface of the mounting section, the inner surface facing the second tine of the forklift.

In variations of the present invention, the compartment is disposed on the bottom surface of the first support and protective structure.

Preferably, the smart logistic system further includes a smart pallet having a pallet, a RFID tag and housing for the RFID tag. Data stored on the RFID tag can be operatively read by the RFID reader, disposed on the forklift tine, from any of the four sides of the pallet. Optionally, an RFID reader that is operatively engaged with the pallet can read RFID tags attached to packages disposed on the pallet.

Preferably, the smart logistic system further includes a load sensor disposed on the top surface of the first support and protective structure. The load sensor is configured to detect a load placed on the top surface thereby creating a load status data. The load sensor is operatively connected to the RFID reader, thereby permitting transmission of the load status data to a remote unit.

Optionally, the smart logistic system further includes a control unit, preferably disposed on forklift, the control unit including a processor, a monitor and a transmitting/receiving unit. The transmitting/receiving unit is wirelessly connected to a respective at least one transmitting/receiving remote device, thereby permitting communication between the transmitting/receiving unit and the at least one transmitting/receiving remote device. Optionally, the processor displays on the monitor real time data communicated by the RFID reader to an operator of the forklift.

Optionally, the smart logistic system further includes a central logistics processor includes a processor and a transmitting/receiving unit. The transmitting/receiving unit of the central logistics processor is wirelessly connected to respective at least one remote data units, thereby permitting communication between the transmitting/receiving unit of the central logistics processor and the remote data unit. In variations of the present invention, the remote data unit is the RF reader mounted on the first tine of the forklift. In other variations of the present invention, the remote data unit is the control unit of the forklift. The processor executes an electromagnetic signal carrying computer readable instructions for filtering out none relevant RFID tags read by the RFID reader, thereby reducing the processing load off the central logistics processor. The central logistics processor is managing a body selected from the group consisting essentially of a production plant, a distribution center and a warehouse.

In variations of the present invention, the RF signals are UHF RF signals.

In variations of the present invention, the RF signals are HF RF signals.

Optionally, the smart logistic system further includes a RFID tag being securely attached substantially adjacent to a stationary surface, wherein the RFID tag is operatively read by the RFID reader located within an operational distance from the RFID tag. In variations of the present invention, the stationary surface is a shelf. In other variations of the present invention, the stationary surface is a floor.

In variations of the present invention, the smart logistic system further includes a second portable support and protective structure adapted for mounting on a first tine of the forklift, the second support and protective structure including a second mounting section and a second component section each extending along at least a portion of the second support and protective structure, the second mounting section configured to secure the second support and protective structure to the second tine of the forklift and the second component section including a second compartment. Coupled with the second portable support and protective structure, the smart logistic system further includes a second RFID reader securely accommodated inside the second compartment, a second RFID antenna and a second power source securely accommodated in the second component section. The second RFID reader is operatively coupled to the second RFID antenna, the second RFID antenna being mounted onto the second support and protective structure so as to permit transmitting and receiving of RF signals. Preferably, at least a portion of the second support and protective structure is configured to be used as the second RFID antenna.

An aspect of the present invention is to provide a method of collecting and updating inventory tracking data in a material handling environment using a smart logistic system, the method including the steps of:
a) providing inventory RFID tags on a pallet and/or on a load positioned on the pallet, wherein the inventory RFID tags represent inventory contents;
b) positioning a forklift tine, having a RFID reader mounted on the forklift tine, under the pallet;
c) transmitting a RF signal by the RFID reader; and
d) reading information from one or more of the inventory RFID tags by the RFID, whereby creating read tag data.

Optionally, the method further includes the step of transmitting the read tag data to a control unit disposed in the forklift using RF signals.

Optionally, the method further includes the step of transmitting the read tag data to a central logistics processor using RF signals.

Optionally, the method further includes the steps of providing location RFID tags at a known location, wherein the location RFID tags represent a shelf lot, a floor lot or any other location the like, reading the location RFID tag off a shelf lot or a floor lot, and associating a load tag, being placed at the shelf lot or the floor lot by the forklift, with the location RFID tag marking the shelf lot or the floor lot.

An aspect of the present invention is to provide a self sufficient RFID reading device suitable for mounting on a first tine of a forklift, the first tine includes a horizontal portion for engaging a load, the horizontal portion including a top surface, a bottom surface, an inner surface facing the second tine and an outer side surface facing away from the second tine, the RFID reader including a housing adapted for securely mounting on the first tine of the forklift a RFID reader is securely accommodated inside the housing, a RFID antenna, and a power source securely accommodated in the housing, wherein the RFID reader is operatively coupled to the RFID antenna, and wherein the RFID antenna is mounted onto the first tine so as to permit transmitting and receiving of RF signals.

Optionally, the housing is fitted into a notch in the first tine. The mounting section includes a top surface and a bottom surface, wherein the inner surface of the first tine include the notch. Optionally, corresponding walls of the housing mounted over the notch and essentially flush with one of at least the top and the inner surfaces of the tine. Preferably, the housing is mounted essentially flush with the inner surface of the tine.

Optionally, the housing is mounted on the bottom surface of the tine.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 (prior art) shows a conventional RFID based IT system for managing production and logistic activities;

FIG. 2 (prior art) illustrates the influence of the angle between the surface of an RFID tag and the transmission axis of the RF signal transmitted by an RFID reader;

FIG. 3 (prior art) shows a schematic perspective view of an RFID device containing an RFID tag for a pallet;

FIG. 4 (prior art) illustrates a bottom view of the pallet shown in FIG. 3;

FIG. 5 (prior art) illustrates the indifference of the approach direction of a forklift reading the RFID tag embedded inside the pallet shown in FIG. 3;

FIG. 6 (prior art) which schematically illustrates a RFID antenna for mounting on a forklift tine, being connected to an RFID reader disposed on the forklift, typically at a static location such as the forklift mast;

FIG. 7 illustrates the indifference of the approach direction of a forklift reading the RFID tag embedded inside the pallet shown in FIG. 3, the forklift having a sleeve with an embedded RFID reader;

FIG. 8a schematically illustrates a wireless sleeve, according to aspects of the present invention, having an RFID reader embedded into the sleeve;

FIG. 8b schematically illustrates a wired sleeve, according to aspects of the present invention, having an RFID reader embedded into the sleeve;

FIG. 9 illustrates the sleeve shown in FIG. 8, being mounted onto the right tine of a forklift;

FIG. 10 schematically illustrates the sleeve shown in FIG. 8, wirelessly communicating with a control unit, typically mounted in the truck cabin, which in turn communicating with an access point which typically communicates through LAN to the central IT system, according to variations of the present invention;

FIG. 11 schematically illustrates an RFID reader embedded into the tine of a forklift, according to variations of the present invention;

FIG. 12 schematically illustrates an RFID reader affixed under the tine of a forklift, according to variations of the present invention;

FIG. 13 schematically illustrates the usage of smart pallets in the supply chain, controlled by a central logistics processor, according to aspects of the present invention;

FIG. 14 schematically illustrates another example in the supply chain, showing the conveyance of products manufacture in a plant to a transporting truck, using smart pallets, according to variations of the present invention;

FIG. 15 schematically illustrates another example in the supply chain, showing the conveyance of smart packages packed on a smart pallet from a transporting truck to a distribution center;

FIG. 16 illustrates a truck loaded with smart pallets driving through an RFID reading gate, according to variations of the present invention;

FIG. 17 illustrates a smart forklift driving through an RFID reading gate, according to variations of the present invention;

FIG. 18 illustrates a smart pallets moving on convey mechanism, according to variations of the present invention; and

FIG. 19 shows a perspective view of a smart container including an RFID device containing an RFID tag as shown in FIGS. 3 and 4; and

FIG. 20 is an example flow diagram of a method of collecting and updating inventory tracking data in a material handling environment, using the smart logistic system of the present invention.

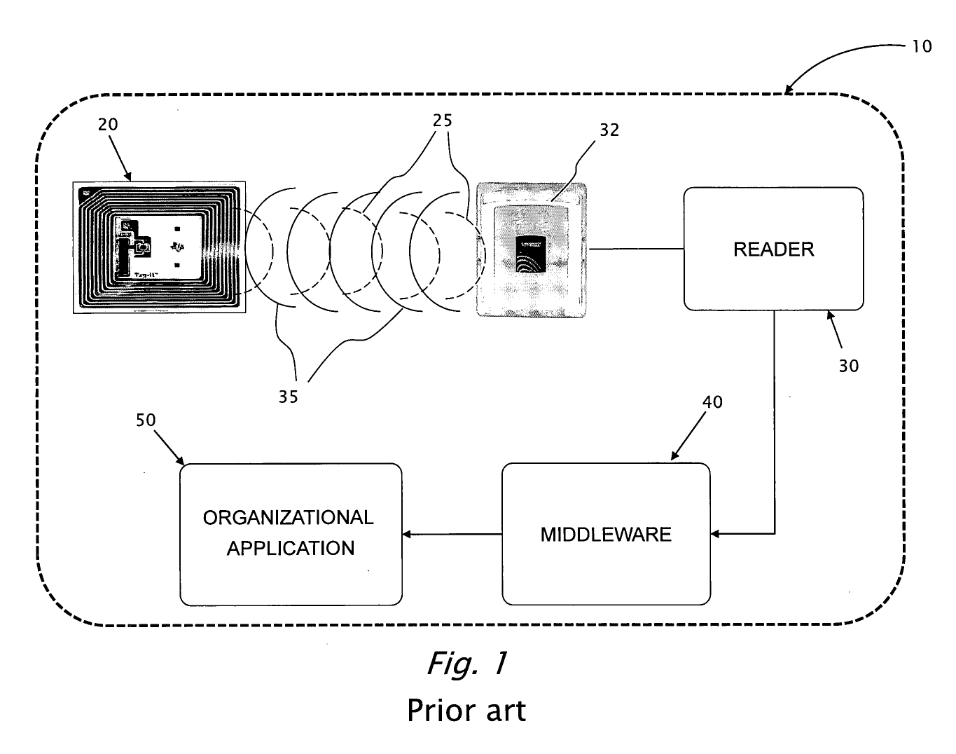

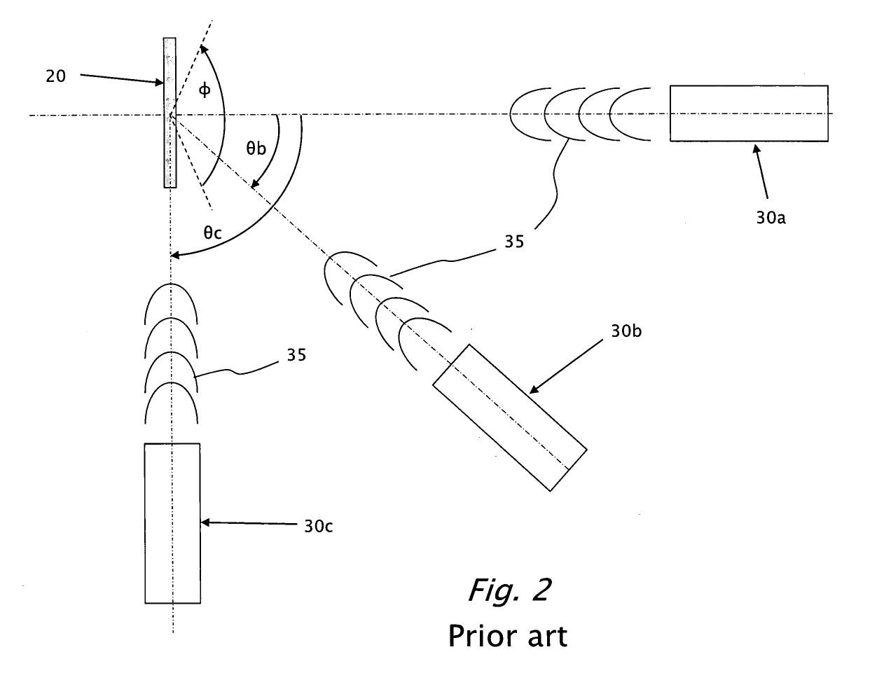

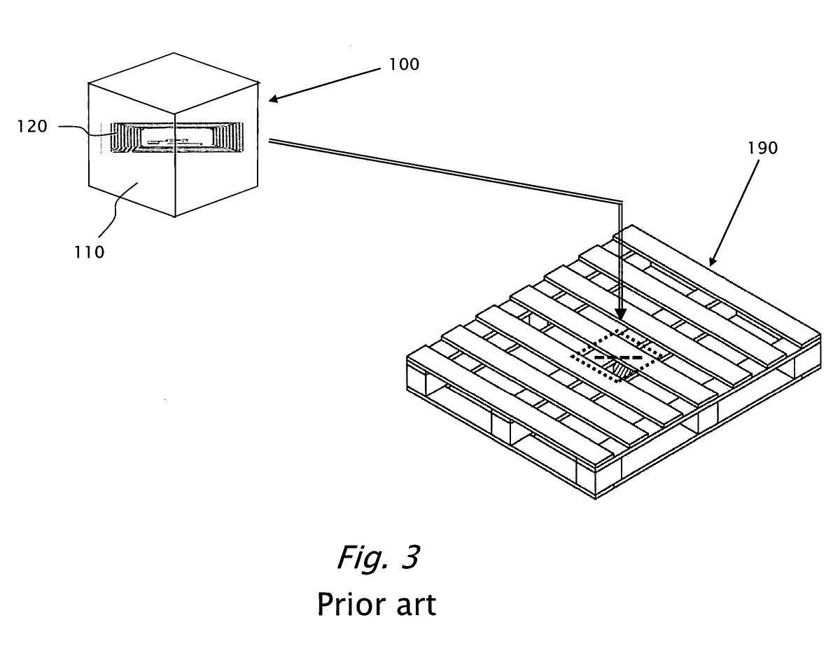

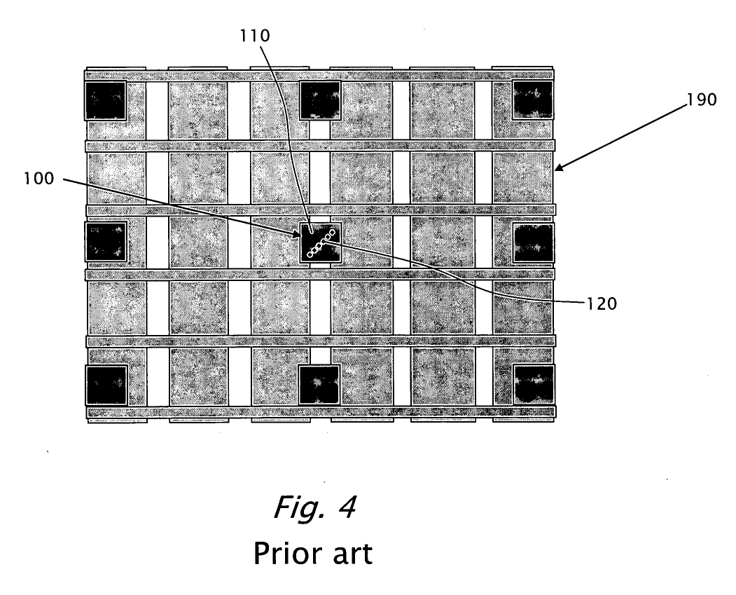

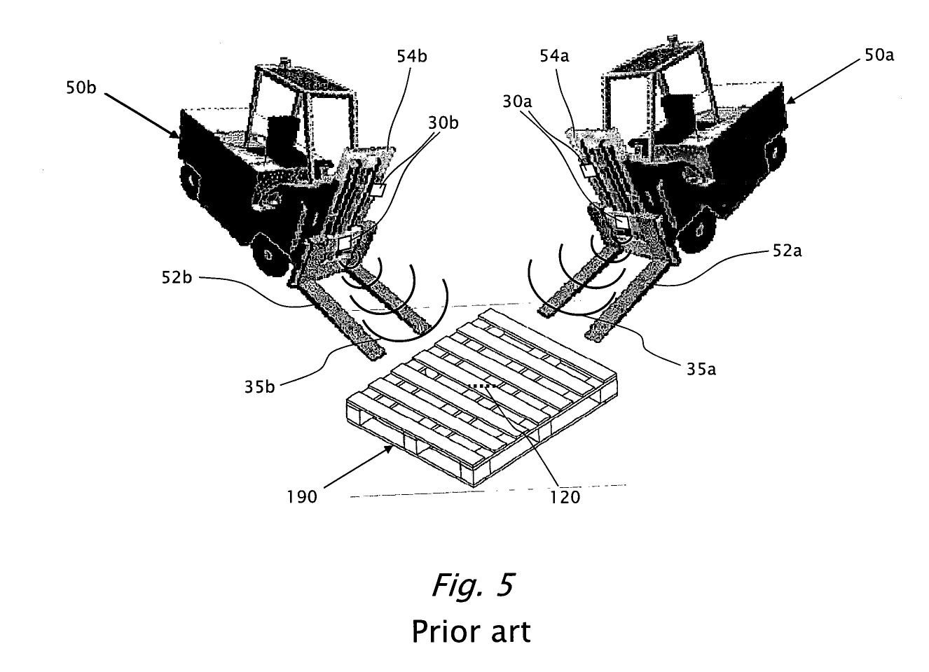

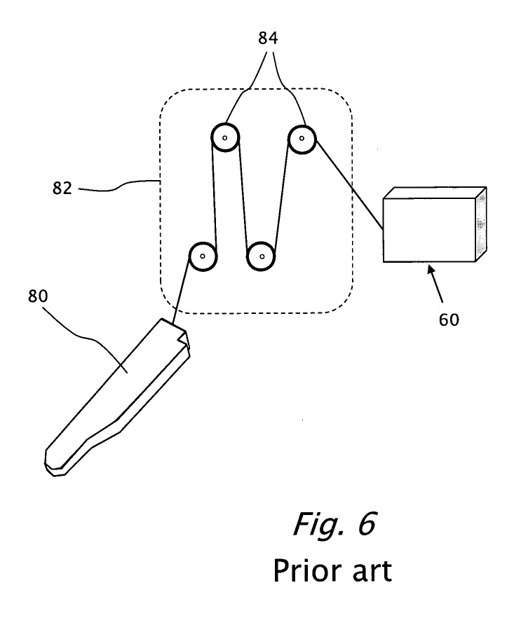

### DESCRIPTION OF THE PREFERRED EMBODIMENTS

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

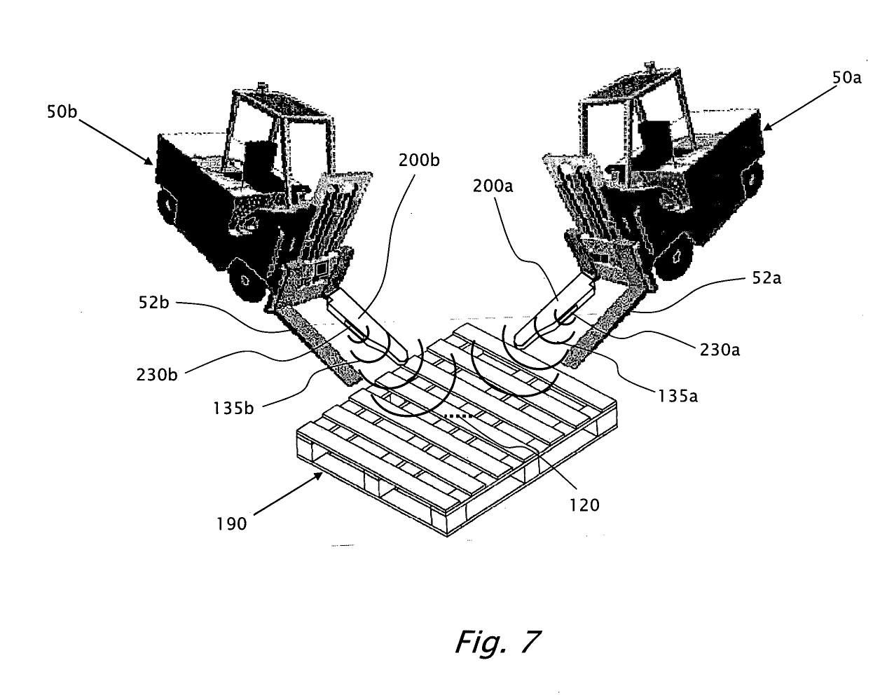

Reference is made to FIG. 7, which illustrates the indifference of the approach direction of forklift 50 reading RFID tag 120 using waves 135, wherein RFID tag 120 is embedded inside pallet 190. Forklift 50 is equipped with portable sleeve 200, which sleeve 200 includes embedded RFID reader 230, sleeve 200 being a support and protective structure adapted for mounting on forklift tine 52.

It should be noted that RFID device 100 is sealed to protect smart tag 120 from fluid or humidity penetration, and is integrated into pallet 190. It should be further noted that pallet 190 and/or device 100 can be made of any common material used for pallets, including wood, plastic, etc.

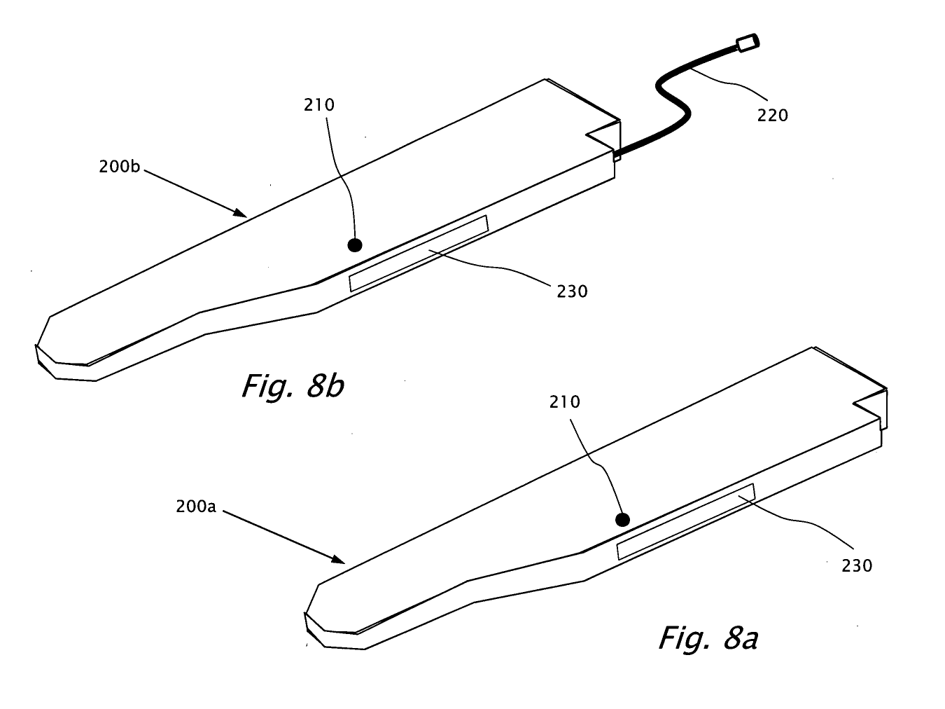

Reference is now made to FIG. 8a, which schematically illustrates wireless sleeve 200a, according to aspects of the present invention, having RFID reader 230 embedded into sleeve 200a. RFID reader 230 is typically self sufficient using a power source such as a battery (not shown).

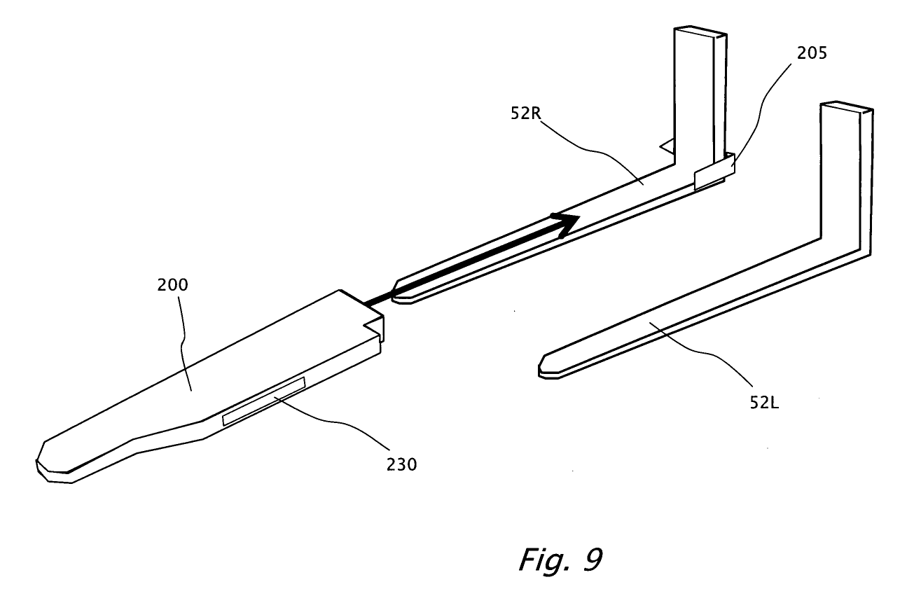

Reference is also made to FIG. 9, which illustrates sleeve 200 being mounted onto the right tine 52R of a forklift. When being mounted onto forklift tine 52, sleeve 200 can be attached to tine 52 by attaching means 205, which can be any attaching means. Being portable, sleeve 200 can be easily mounted and/or removed from forklift tine 52.

When in operational mode, RFID reader 230 reads one or more RFID tags situated in the vicinity of RFID reader 230 and the data transmitted to a designated control unit, typically a computer disposed in the forklift cabin. RFID reader 230 includes an antenna, whereas at least a portion of sleeve 200 is preferably configured to be used as the RFID antenna of RFID reader 230, which can be any conventional type antenna. Sleeve 200 may further include more logic control embodied in electronic circuits. Preferably, sleeve 200 further includes load sensor 210, such as an optical or sonic sensor (or any other technology), which detects and indicates whether there is a load on top of sleeve 200. This information is typically transmitted to a designated computer. Sensing whether tine 52 is loaded or not enables to filter out RFID readouts that are not from loads loaded on tine 52.

It should be noted that RFID reader 230, being exposed to rough operational environment, is protected by a sealed and rigid shield. It should be able to operate in a wet environment and to sustain forklift 50 vibration other operational forces.

It should be further noted that the battery (not shown) provides power to all electronic components of sleeve 200, including RFID reader 230 and load sensor 210.

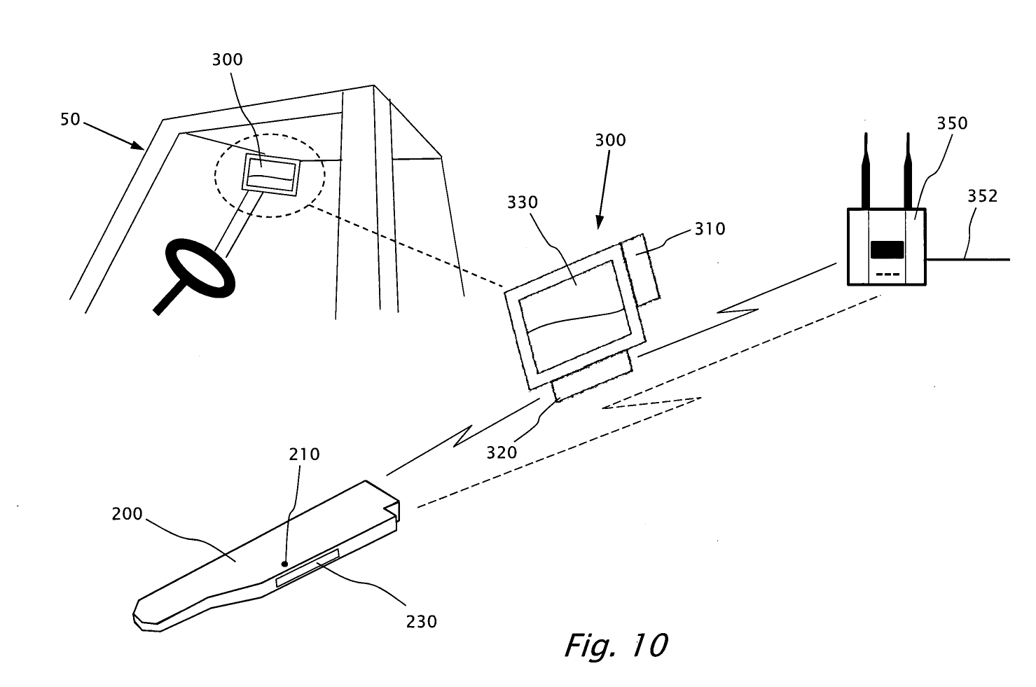

Reference is also made to FIG. 10, which illustrates RFID reader 230 of sleeve 200 wirelessly communicating with control unit 300, which optionally communicating with access point 350 which typically communicate through LAN 352 to the central IT system. Control unit 300 is typically a PC computer disposed in the cabin of forklift 50. Control unit 300 includes a processor 310, a transmitting/receiving unit 320 and preferably a monitor 330. Transmitting/receiving unit 320 is wirelessly connected to respective at least one transmitting/receiving remote device, thereby permitting communication between transmitting/receiving unit 320 and the at least one transmitting/receiving remote device. Optionally, processor 310 displays real time data on monitor 330 communicated by RFID reader 230 to an operator of forklift 50. The data displayed on monitor 330 is selected from the group including, data read from one or more tags, battery level and other maintenance data, available remote device with which control unit 300 can communicated and other data.

Preferably, processor 310 executes an electromagnetic signal carrying computer readable instructions for filtering out none relevant RFID tags read by RFID reader 230, thereby reducing the load the wireless network and reducing the processing load off the central logistics processor.

The transmission from sleeve 200 to control unit 300 is preferably performed through wireless communication means, but the transmission can also be performed through wired communication means 220, as shown in FIG. 8b. FIG. 8b schematically illustrates wired sleeve 200b, according to aspects of the present invention, having RFID reader 230 embedded into sleeve 200b. It should be noted that in a wired embodiment, operational power may be obtained through a wired solution rather than batteries.

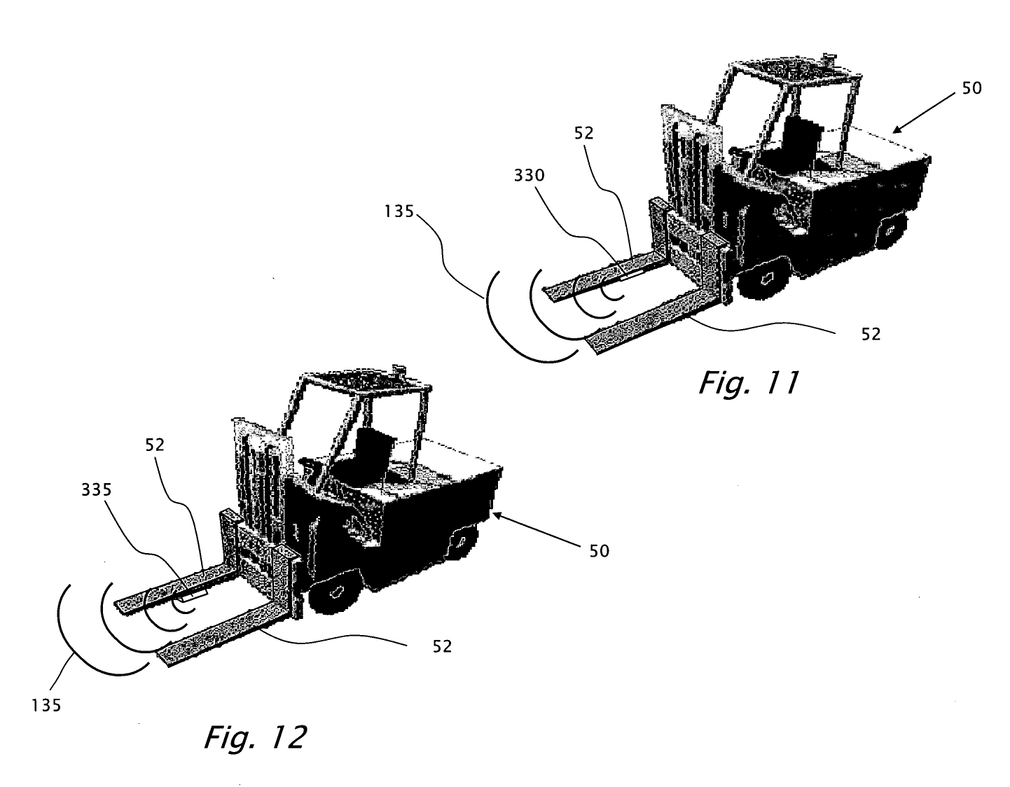

In variations of the present invention, the RFID reader is built into tine 52 of forklift 50. Reference is now made to FIG. 11, which schematically illustrates RFID reader 330 embedded into tine 52 of a forklift 50, according to variations of the present invention. In other variations of the present invention, the RFID reader is affixed to tine 52 of forklift 50. Reference is now made to FIG. 12, which schematically illustrates RFID reader 335 affixed under tine 52 of a forklift 50, according to variations of the present invention.

An aspect of the present invention is to provide an RFID based smart logistic system, designed to provide manufacturers with an automatic, hands-free, fast and advanced solution in order to track, monitor and control the logistic process. The RFID based smart logistic system of the present invention will be describe through an example of the usage made with smart pallets 190 in the supply chain, with no limitation on the scope of this aspect present invention.

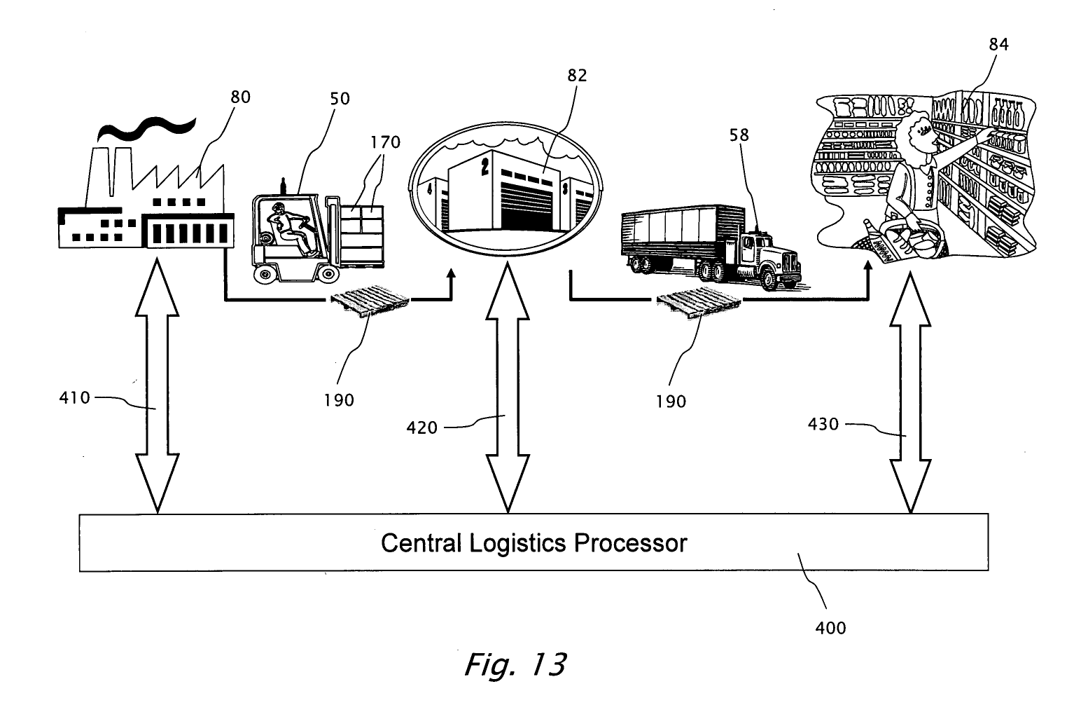

Reference is now made to FIG. 13, which schematically illustrates the usage of smart pallets 190 in the supply chain, controlled by central logistics processor 400, according to aspects of the present invention. Central logistics processor 400 controls the logistics of at least one of the following sites:
a) Production plant 80, through control channel 410;
b) Distribution Center 82, through control channel 420; and
c) Buyer warehouse 84, through control channel 430.

Control channel 410 typically performs one or more of the following tasks:
a) Packing goods in smart packages 170, optionally having an RFID tag.
   A smart forklift 50, having an RFID reader 230 disposed on at least one of tines 52, selects a pallet 190, reading tag 120 mounted in pallet 190. Then, smart forklift 50 picks up packages 170, reading the RFID tag affixed to each package 170.
b) Pack packages 170 on smart pallets 190.
   Smart forklift 50, packs packages 170 onto the selected smart pallets 190.
c) Send goods on smart pallets 190 to distribution center 82.
   Smart forklift 50, transfers the goods packed on smart pallets 190 to distribution center 82.
d) Others.

In variations of the present invention, RFID reader 230 of sleeve 200 directly and wirelessly communicates with central logistics processor 400.

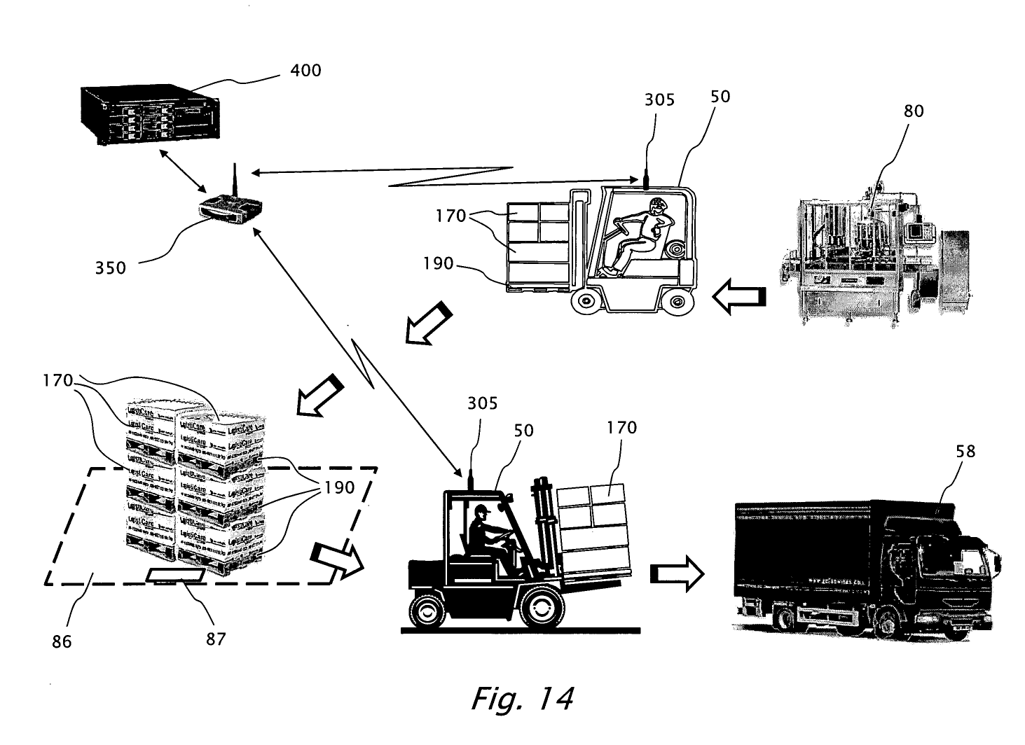

Reference is also made to FIG. 14, which schematically illustrates another example in the supply chain, showing the conveyance of products manufacture in plant 80 to a transporting truck 58, using smart pallets 190. After selecting a smart pallet 190 RFID reader 230 transmits the specific pallet 190 ID data to control unit 300 disposed on smart forklift 50. Smart forklift 50, in turn, uses antenna 305 to further transmit the data to access point 350, which transfers the data to central logistics processor 400. Smart forklift 50, picks smart packages 170 containing the manufactured product, and places packages 170 onto the selected pallet 190. The information from packages 170 and the associated pallet 190 are transmitted to central logistics processor 400 as before.

Optionally, smart forklift 50 transfers packed pallets 190 to an interim floor location 86. The interim floor location 86 may be subdivided into individual unique lots, each marked by a location RFID tag 87. Each “floor lot” may accommodate a single unique pallet/load/package. When smart forklift 50 places a specific pallet 190 on such a lot, RFID reader 230 reads the unique RFID tag 87 to associate the specific pallet 190 with a specific a lot. This information is transferred to central logistics processor 400 via control unit 300 and access point 350. Smart forklift 50 can then transfers packed pallets 190 to either a transporting truck 58, or directly to a distribution center 82.

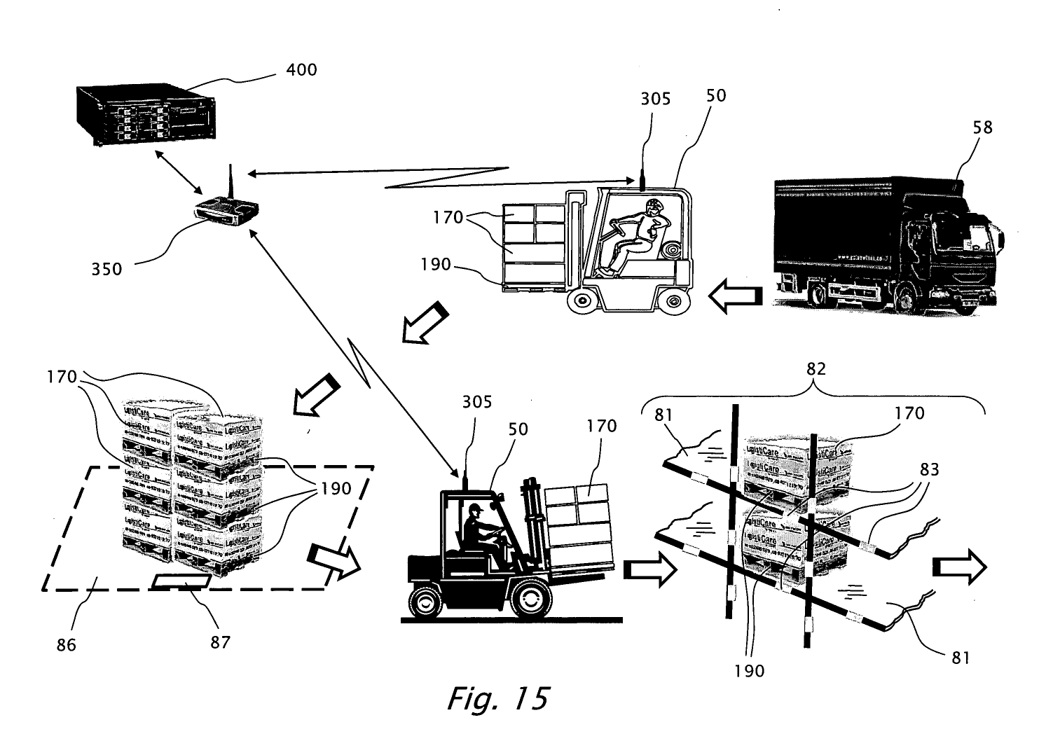

Reference is also made to FIG. 15, which schematically illustrates another example in the supply chain, showing the conveyance of smart packages 170 packed on smart pallets 190 from transporting truck 58 to a distribution center 82. When picking up a packed smart pallet 190 with smart forklift 50, RFID reader 230 transmits the specific pallet 190 ID data to control unit 300 disposed on smart forklift 50. Smart forklift 50, in turn, uses antenna 305 to further transmit the data to access point 350 which transfers the data to central logistics processor 400.

Smart forklift 50, places packages 170 packed on a pallet 190 on selves 81 at unique locations marked by a location RFID tag 83. Each package 170, or pallet 190, or any other uniquely tagged load is placed at a unique location on selves 81, the unique shelf location also referred to as a “shelf lot”. When smart forklift 50 places a specific pallet 190 at a unique shelf location, RFID reader 230 reads the unique shelf location RFID tag 83 to associate the specific pallet 190 with the specific shelf location. This information is transferred to central logistics processor 400 via control unit 300 and access point 350.

In variations of the present invention, the RFID reader communicates with central logistics processor 400 through access point 350, not having to first communicate RFID data to control unit 300, mounted on smart forklift 50.

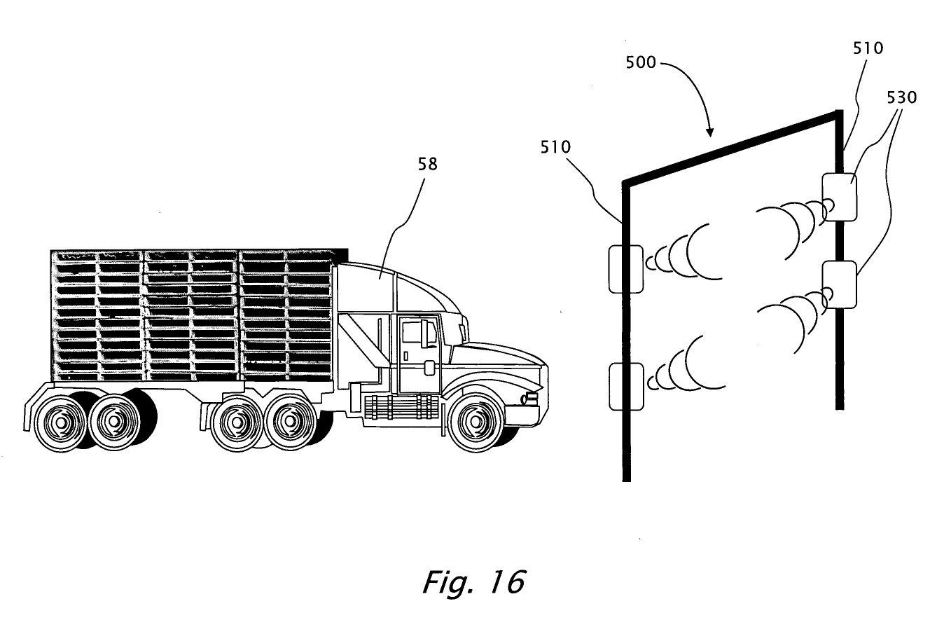

The RFID based smart logistic system of the present invention may further include control station to further control conveyance of smart pallet 190. Reference is now made to FIG. 16, which illustrates truck 58 with a load of smart pallets 190, for example pallets 190 returning for refund from a buyer's warehouse 84. Truck 58 drives through gate 500, which includes multiple RFID readers 530 typically mounted on posts 510 of gate 500, reading all the returning pallets 190, and transmitting the read data to central logistics processor 400, typically through access point 350.

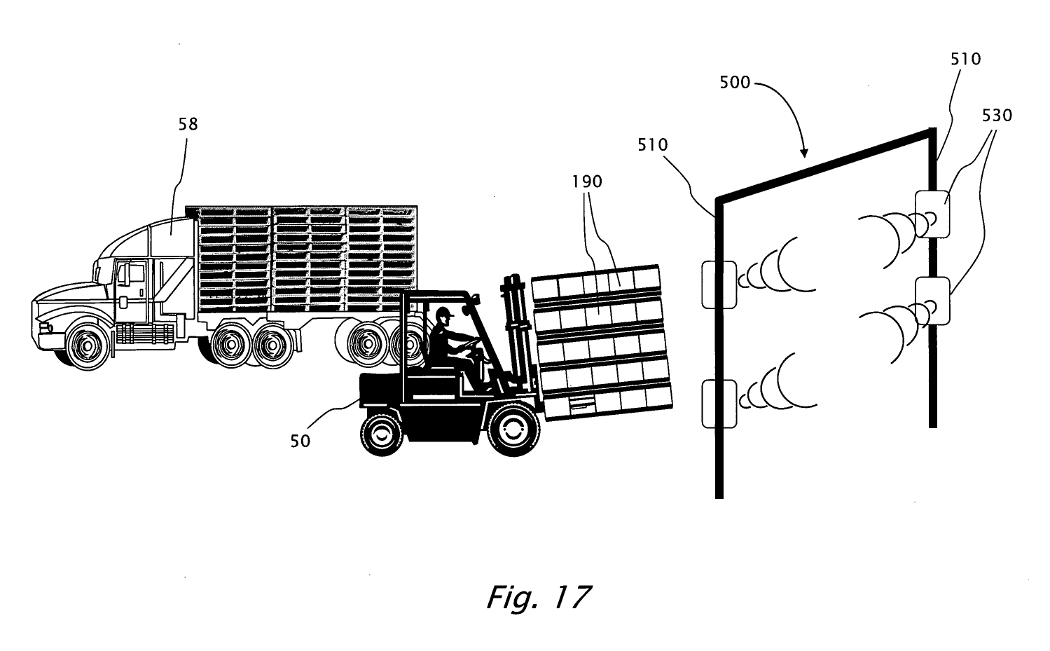

Reference is also made to FIG. 17, which illustrates smart forklift 50 unloading smart pallets 190 from truck 58, for example pallets 190 returning for refund from a buyer's warehouse 84. Smart forklift 50 drives through gate 500, which includes multiple RFID readers 530, reading all the returning pallets 190, and transmitting the read data to central logistics processor 400, typically through access point 350.

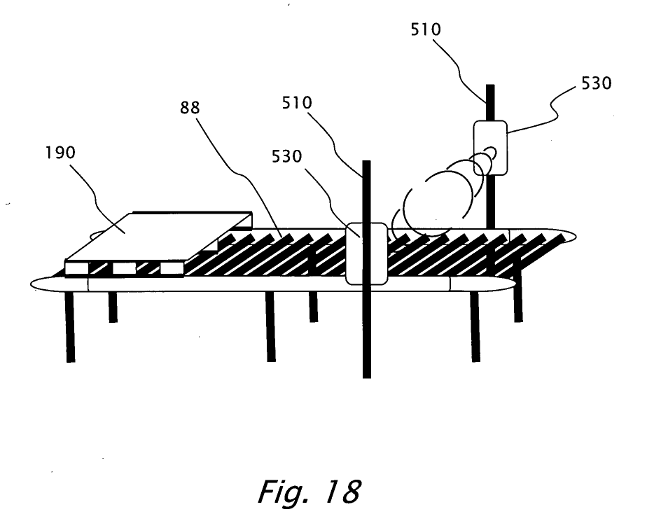

Reference is also made to FIG. 18, which illustrates smart pallets 190 moving on convey mechanism 88. Pallet 190 moves through a gate including RFID readers 530, reading the RFID tag off pallet 190, and transmitting the read data to central logistics processor 400, typically through access point 350.

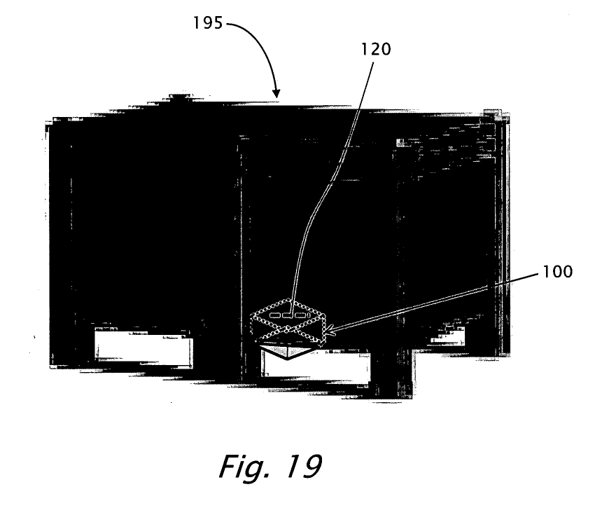

In variations of the present invention, RFID tag device is affixed to a smart container, rather than to a smart pallet. FIG. 19 shows a perspective view of smart container 195 including RFID device 100, which contains RFID tag 120. Smart container 195 can be read by RFID reader 230, mounted on tine 52 of smart forklift 50 just as smart pallet 190 is read by RFID reader 230.

In variations of the present invention, RFID reader 230 can also write data onto one or more RFID tags.

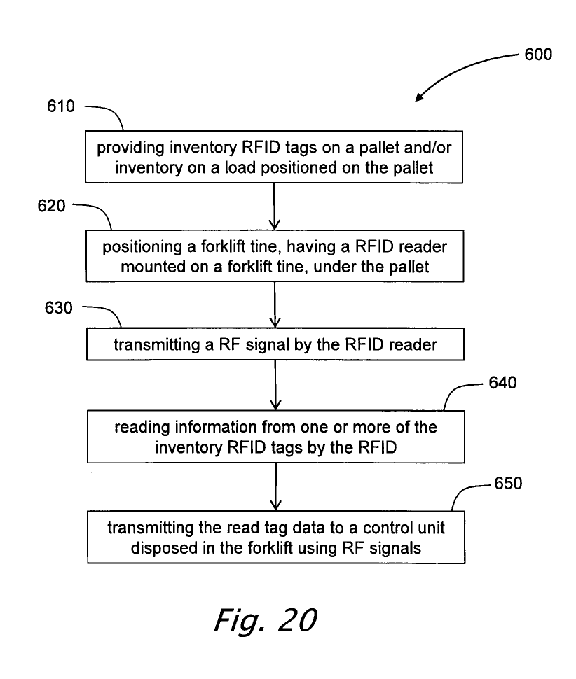

An aspect of the present invention is to provide a method 600 of collecting and updating inventory tracking data in a material handling environment, using the smart logistic system of the present invention, as outlined in FIG. 20. Method 600 including the steps of:
Step 610—providing inventory RFID tags on a pallet and/or on a load positioned on the pallet, wherein the inventory RFID tags represent inventory contents.
Step 620—positioning a forklift tine, having a RFID reader mounted on the forklift tine, under the pallet;
Step 630—transmitting a RF signal by the RFID reader; Step 640—reading information from one or more of the inventory RFID tags by the RFID, whereby creating read tag data; and preferably
Step 650—transmitting the read tag data to a control unit disposed in the forklift using RF signals.

Preferably, method 600 further includes the step of transmitting the read tag data to a central logistics processor by the control unit, using RF signals. In variations of the present invention the read tag data is transmitted to a central logistics processor by the RFID reader, using RF signals.

Optionally, method 600 further includes the steps of
a) providing location RFID tags at a known location, wherein the location RFID tags represent a shelf lot, a floor lot or any other location the like;
b) reading the location RFID tag off a shelf lot or a floor lot; and
c) associating a load tag, being placed at the shelf lot or the floor lot by the forklift, with the location RFID tag marking the shelf lot or the floor lot.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

1. A smart logistic system for interrogating radio frequency identification (RFID) tags, comprising: a) a first portable support and protective structure adapted for mounting on a first tine of said forklift, said first support and protective structure comprising a mounting section, includes a top surface and a bottom surface, and a component section each extending along at least a portion of said first support and protective structure, said mounting section configured to secure said first support and protective structure to said first tine and said component section including a compartment; b) a RFID reader securely accommodated inside said compartment; c) a RFID antenna; and d) a power source securely accommodated in said component section, wherein said RFID reader is operatively coupled to said RFID antenna; wherein said RFID reader is self sufficient; and wherein said RFID antenna is mounted onto said first support and protective structure so as to permit transmitting and receiving of radio frequency (RF) signals.

2. The smart logistic system of claim 1, wherein at least a portion of said first support and protective structure is configured to be used as said RFID antenna.

3. The smart logistic system of claim 1, wherein said first support and protective structure being portable and said RFID reader being self sufficient, said smart logistic system is deployable to another tine of a forklift within seconds.

4. The smart logistic system of claim 1, wherein said mounting section further includes an inner surface facing the second tine of said forklift, and wherein said compartment is disposed inside said mounting section and essentially flush with said inner surface.

5. The smart logistic system of claim 1, wherein at least a portion of said first support and wherein said compartment is disposed on said bottom surface.

6. The smart logistic system of claim 1 further comprising: e) a smart pallet including: i. a pallet; ii. a RFID tag; and iii. a housing for said RFID tag, wherein data stored on said RFID tag can be operatively read by said RFID reader disposed on said forklift tine from any of four sides of said pallet.

7. The smart logistic system of claim 6, wherein said RFID reader operatively engaged with said pallet can read RFID tags attached to packages disposed on said pallet.

8. The smart logistic system of claim 1 further comprising: f) a load sensor disposed on said top surface of said first support and protective structure, wherein said load sensor is configured to detect a load placed on said top surface thereby creating a load status data; and wherein said load sensor is operatively connected to said RFID reader thereby permitting transmission of said load status data.

9. The smart logistic system of claim 1 further comprising: g) a control unit disposed on said forklift and including: i. a processor; ii. a monitor; and iii. a transmitting/receiving unit, wherein said transmitting/receiving unit is wirelessly connected to respective at least one transmitting/receiving remote device, thereby permitting communication between said transmitting/receiving unit and said at least one transmitting/receiving remote device.

10. The smart logistic system of claim 9, wherein said processor displays on said monitor real time data communicated by said RFID reader to an operator of said forklift.

11. The smart logistic system of claim 1 further comprising: h) a central logistics processor including: i. a processor; and ii. a transmitting/receiving unit, wherein said transmitting/receiving unit of said central logistics processor is wirelessly connected to respective at least one remote data units, thereby permitting communication between said transmitting/receiving unit of said central logistics processor and said remote data unit.

12. The smart logistic system of claim 11, wherein said remote data unit is said RF reader mounted on said first tine of said forklift.

13. The smart logistic system of claim 11, wherein said remote data unit is said control unit of said forklift.

14. The smart logistic system of claim 11, wherein said processor executes an electromagnetic signal carrying computer readable instructions for filtering out none relevant RFID tags read by said RFID reader, thereby reducing the processing load off said central logistics processor.

15. The smart logistic system of claim 11, wherein said central logistics processor is managing a body selected from the group consisting essentially of a production plant, a distribution center and a warehouse.

16. The smart logistic system of claim 1, wherein said RF signals are UHF RF signals.

17. The smart logistic system of claim 1, wherein said RF signals are HF RF signals.

18. The smart logistic system of claim 1 further comprising: i) a RFID tag securely attached substantially adjacent to a stationary surface, wherein said RFID tag is operatively read by said RFID reader located within an operational distance from said RFID tag.

19. The smart logistic system of claim 18, wherein said stationary surface is a shelf.

20. The smart logistic system of claim 18, wherein said stationary surface is a floor.

21. The smart logistic system of claim 1 further comprising: j) a portable second support and protective structure adapted for mounting on a first tine of said forklift, said second support and protective structure comprising a second mounting section and a second component section each extending along at least a portion of said second support and protective structure, said second mounting section configured to secure said second support and protective structure to the second tine of said forklift and said second component section including a second compartment; k) a second RFID reader is securely accommodated inside said second compartment;
1) a second RFID antenna; and m) a second power source securely accommodated in said second component section,
wherein said second RFID reader is operatively coupled to said second RFID antenna; and wherein said second RFID antenna is mounted onto said second support and protective structure so as to permit transmitting and receiving of RF signals.

22. The smart logistic system of claim 21, wherein at least a portion of said second support and protective structure is configured to be used as said second RFID antenna.

23. A method of collecting and updating inventory tracking data in a material handling environment using a smart logistic system, said method comprising the steps of: a) providing inventory RFID tags on a pallet and/or on a load positioned on said pallet, wherein said inventory RFID tags represent inventory contents; b) positioning a forklift tine, having a RFID reader mounted on said forklift tine, under said pallet; c) transmitting a RF signal by said RFID reader; and d) reading information from one or more of said inventory RFID tags by said RFID, whereby creating read tag data.

24. The method of claim 23, further comprising the step of: e) transmitting said read tag data to a control unit disposed in said forklift using RF signals.

25. The method of claim 23, further comprising the step of: f) transmitting said read tag data to a central logistics processor using RF signals.

26. The method of claim 23, further comprising the steps of: g) providing location RFID tags at a known location, wherein said location RFID tags represent a shelf lot, a floor lot or any other location the like; h) reading said location RFID tag off a shelf lot or a floor lot; and i) associating a load tag, being placed at said shelf lot or said floor lot by said forklift, with said location RFID tag marking said shelf lot or said floor lot.

27. The method of claim 23, wherein said RF signals are UHF RF signals.

28. The method of claim 23, wherein said RF signals are HF RF signals.

29. A self sufficient RFID reading device suitable for mounting on a first tine of a forklift, said first tine includes a horizontal portion for engaging a load, said horizontal portion including a top surface, a bottom surface, an inner surface facing the second tine and an outer side surface facing away from said second tine, said RFID reader including: a) a housing adapted for securely mounting on said first tine of said forklift; b) a RFID reader is securely accommodated inside said housing; c) a RFID antenna; and d) a power source securely accommodated in said housing, wherein said RFID reader is operatively coupled to said RFID antenna; wherein said mounting section includes a top surface and a bottom surface; and wherein said RFID antenna is mounted onto said first tine so as to permit transmitting and receiving of radio frequency (RF) signals.

30. The RFID reading device of claim 29, wherein said housing is fitted into a notch in said first tine.

31. The RFID reading device of claim 30, wherein said inner surface of said first tine include said notch.

32. The RFID reading device of claim 30, wherein corresponding walls of said housing mounted over said notch and essentially flush with one of at least said top and said inner surfaces of said tine.

33. The RFID reading device of claim 29, wherein said RF signals are UHF RF signals.

34. The RFID reading device of claim 29, wherein said RF signals are HF RF signals.

35. The RFID reading device of claim 29, wherein said housing is mounted on said bottom surface of said tine.

36. The RFID reading device of claim 35, wherein said housing is mounted essentially flush with said inner surface of said tine.
